(19) United States
(12) Patent Application Publication
(10) Pub. No.: US 2012/0253094 A1
(43) Pub. Date: Oct. 4, 2012

(54) STABILIZING HAZARDOUS WASTES USING WASTE BYPRODUCTS

(75) Inventor: Anthony J. Kriech, Indianapolis, IN (US)

(73) Assignee: HERITAGE ENVIRONMENTAL SERVICES, LLC, Indianapolis, IN (US)

(21) Appl. No.: 13/430,336

(22) Filed: Mar. 26, 2012

Related U.S. Application Data
(60) Provisional application No. 61/468,619, filed on Mar. 29, 2011.

(51) Int. Cl. A62D 3/33

(52) U.S. Cl. 588/315

(57) ABSTRACT

A method of disposing of two or more waste materials, including at least one hazardous waste material, which method includes the steps of: obtaining a waste byproduct; producing a reagent from the waste byproduct which reagent includes one or more contaminates; obtaining a waste material containing one or more hazardous heavy metals; treating the hazardous heavy metal containing waste material with the reagent from step b) to stabilize the hazardous heavy metal containing waste material; and disposing of the stabilized hazardous heavy metal containing waste material. According to one embodiment the waste byproduct is gypsum. The gypsum can be obtained from a flue gas desulfurization process. According to another embodiment the waste byproduct is a calcium carbonate containing byproduct which is reacted with acid tar to produce calcium sulfide. The calcium carbonate containing byproduct can come from a Solvay process.

### RELATED APPLICAION

This application is based on U.S. Provisional Application Ser. No. 61/468,619, filed Mar. 29, 2011 to which priority if claimed under 35 U.S.C. §120 and of which the entire specification is hereby expressly incorporated by reference.

### BACKGROUND

The present invention relates generally to waste materials, including the combined productive use and stabilization of different waste materials. More particularly the present invention relates to the processing of one waste material to produce a reagent that is used to stabilize another waste material. In particular the present invention relates to the stabilization of heavy metal containing waste materials using a calcium sulfide reagent derived from waste byproducts, including gypsum, Solvay process byproducts and acid tar.

The combustion of coal in power generation facilities produces solid wastes, such as bottom and fly ash, and flue gas that are emitted to the atmosphere. Many plants are required to remove SOₓ emissions from the flue gas using flue gas desulfurization (FGD) systems. The three leading FGD technologies used in the U.S. are wet scrubbing (85% of the installations), dry scrubbing (12%), and dry sorbent injection (3%). Wet scrubbers typically remove more than 90% of the SOₓ, compared to dry scrubbers, which remove 80%.

Wet FGD technologies have in common a slurry reactor section and a solids dewatering section. Various types of absorbers have been used, including packed and tray towers, venturi scrubbers, and spray scrubbers in the reactor section. The absorbers neutralize the acidic gasses with an alkaline slurry of lime, sodium hydroxide, or limestone. For a number of economic reasons, newer scrubbers tend to use limestone slurry.

When limestone reacts with SOx in the reducing conditions of the absorber, SO₂ (the major component of SOx) is converted into sulfite, and a slurry rich in calcium sulfite is produced. Earlier FGD systems (referred to as natural oxidation or inhibited oxidation systems) produced a calcium sulfite by-product. Newer FGD systems employ an oxidation reactor in which the calcium sulfite slurry is converted to calcium sulfate (gypsum); these are referred to as limestone forced oxidation (LSFO) FGD systems.

World coal-fired power plant capacity will grow from 1,759,000 MW in 2010 to 2,384,000 MW in 2020. Some 80,000 MW will be replaced. So there will be 705,000 MW of new coal-fired boilers built. In a survey conducted by the USGS in 1999 it was found that about 80 domestic coal-fired electric utilities generated more than 22.3 million metric tons of gypsum. Worldwide the amount of gypsum produced by coal-fired power plants has increased dramatically and will continue to increase.

The recycling of waste gypsum boards for the production of calcium sulfide by reductive decomposition of gypsum was investigated by Mihara et al. (Utilization of Calcium Sulfide Derived from Waste Gypsum Board for Metal-Containing Wastewater, Global NEST Journal, Vol. 10, No 1, pp 101-107, 2008). Mihara et al. found that CaS could be effectively generated by CaSO₄ reductive decomposition with graphite and the CaS content in the final product was greater than 80% when the reductive decomposition was carried out for one hour at a temperature of 1273 K, under N₂ atmosphere.

U.S. Pat. No. 3,640,682, to Smith et al. discloses a method that lowers the temperature normally required to reduce or decompose calcium sulfate into calcium sulfide in which calcium sulfate is reduced to calcium sulfide by a reductant such as hydrogen, carbon monoxide, coke, or hydrocarbons; the rate of reaction being increased by the addition of a small amount of an accelerator agent, comprising sulfur, sulfur dioxide, a sulfur compound which will generate sulfur vapor, or a gaseous sulfur such as sulfur dioxide which will react or decompose to generate sulfur vapor or gaseous sulfide

U.S. Pat. No. 4,348,299 to Okamoto et al. discloses a method for preparing an inorganic sulfide material that involves heating a mixture comprising at least one member of the group consisting of oxidic materials of calcium, strontium and combinations thereof at temperatures between about 800° C. and 1200° C. together with a reactive sulfurizing flux.

U.S. Pat. No. 4,503,018 to Gardner et al. discloses a process to convert phosphogypsum into sulfuric acid and lime or cement which uses a travelling grate, carousel-type mechanism.

U.S. Pat. No. 6,337,058 to Williams et al. discloses a method and apparatus for producing calcium sulfide in which the reactants, gypsum and charcoal are passed through one or more drums by a screw conveyor.

When calcium sulfide is produced from waste gypsum it is usually contaminated with silica or magnesium that is found in the limestone that is used in the desulfurization process of the flue gas. This contamination limits the use of the resulting calcium sulfide as a reagent.

Acid tars are waste residues of obsolete benzole refining, oil re-refining and white oil production processes. Acid tars are black, acidic, viscous semi-liquids comprising an extremely complex mixture of water, sulfuric acids and a large range of organic compounds.

Acid tars were often dumped into excavations and existing holes in the ground together with various co-disposed materials without any treatment or engineered lining system leaving a legacy of acid tar lagoons.

Acid tars may pose potential risks to human health and the environment because of their acidity, volatiles and other hazardous components. The major contamination pathways of acid tar lagoons are considered to be direct contact, gas emission, bulk tar migration offsite, and surface and ground water contamination.

The Solvay process, also referred to as the ammonia-soda process, is the major industrial process for the production of soda ash (sodium carbonate, Na₂CO₃). The Solvay process results in the production of soda ash (predominantly sodium carbonate) from brine (as a source of sodium chloride (NaCl)) and from limestone (as a source of calcium carbonate, CaCO₃). The overall process is:

2 NaCl+CaCO₃→Na₂CO₃+CaCl₂

Not all of the limestone that is calcined is converted to quicklime and carbon dioxide; the residual calcium carbonate and other components of the limestone become byproduct wastes. In 2009 14.5 million tons of soda ash were produced in the United States, generating a significant amount of calcium carbonate, mixed with other components of the limestone, as a waste byproduct.

The present invention provides a process for producing calcium sulfide from wastes such as gypsum and using the resulting calcium sulfide to stabilize heavy metal contaminated waste materials.

The present invention further provides a process for producing calcium sulfide from wastes such as acid tar and waste sodium carbonate such as a Solvay process byproduct and using the resulting calcium sulfide to stabilize heavy metal contaminated waste materials.

### BRIEF SUMMARY

According to various features, characteristics and embodiments of the present invention which will become apparent as the description thereof proceeds, the present invention provides a method of disposing of two or more waste materials, including at least one hazardous waste material, which method includes the steps of:
a) obtaining a waste byproduct;
b) producing a reagent from the waste byproduct which reagent includes one or more contaminates;
c) obtaining a waste material containing one or more hazardous heavy metals;
d) treating the hazardous heavy metal containing waste material with the reagent from step b) to stabilize the hazardous heavy metal containing waste material; and
e) disposing of the stabilized hazardous heavy metal containing waste material.

The present invention further provides a method of stabilizing heavy metal containing waste materials which method includes the steps of:
a) obtaining a waste byproduct;
b) producing a reagent from the waste byproduct which reagent includes one or more contaminates;
c) obtaining a waste material containing one or more hazardous heavy metals; and
d) treating the hazardous heavy metal containing waste material with the reagent from step b) to stabilize the hazardous heavy metal containing waste material.

The present invention also provides a stabilized heavy metal containing waste material.

### DETAILED DESCRIPTION OF THE DRAWINGS AND THE PRESENTLY PREFERRED EMBODIMENTS

The present invention relates generally to waste materials, including the combined productive use and stabilization of different waste materials. More particularly the present invention relates to the processing of one waste material to produce a reagent that is used to stabilize another waste material. In particular the present invention relates to the stabilization of heavy metal containing waste materials using a calcium sulfide reagent derived from waste byproducts, including gypsum and acid tar.

According to one embodiment of the present invention raw materials for the process, including waste gypsum or calcium sulfate (CaSO₄) and a carbon containing material are mixed together and heated to a temperature sufficient to convert the calcium sulfate (CaSO₄) to calcium sulfide (CaS).

The waste gypsum or calcium sulfate used for purposes of the present invention can include gypsum that is obtained as a byproduct from power plant desulfurization or industrial dry or wet desulfurization processes. This waste gypsum will contain low levels of silica or magnesium from the limestone that is used in the desulfurization process; however, when the resulting calcium sulfide is used to stabilize heavy metal waste materials according to the present invention, the silica or magnesium (or other contaminates) will not adversely affect the ability to use the calcium sulfide to stabilize heavy metal waste materials.

The carbon containing material used for purposes of the present invention can include waste coal, high sulfur petroleum coke, waste carbon anodes or other high carbon materials.

The amount of carbon used for a particular waste gypsum feed material can be easily determined based upon the ability of the carbon to form either CO or CO₂ so as to maintain a reducing atmosphere, i.e. an atmosphere that is rich in CO. The ratio of carbon to calcium sulfate is typically about 20% carbon to about 80% calcium sulfate by weight. The ratios are based on achieving a high CO to CO₂ ratio during the reaction and are based on the initially mixed reactants. The ratio of the carbon to calcium sulfate can be adjusted to as necessary to maintain a reducing atmosphere during the reaction. This allows effective reduction of the calcium sulfate to calcium sulfide and the release of CO₂.

The calcium sulfate/carbon reaction mixture is heated to a temperature within the range of about 800° C. to about 1000° C. and preferably to a temperature of about 900° C. The heating should occur in a low oxygen environment to maintain a reducing atmosphere as discussed above. The reaction can be conducted in a rotary kiln or tunnel kiln or a batch kiln or any type of reactor that can achieve the optimum conditions discussed above.

According to another embodiment of the present invention calcium sulfide is produced from acid tar and calcium carbonate. The calcium carbonate can be obtained as a byproduct of a Solvay process. The byproduct of the Solvay process is primarily calcium carbonate together other components of the limestone used in the Solvay process. The acid tar comprises coal tar and sulfuric acid. According to the present invention the acid tar and Solvay process byproduct are reacted together to produce calcium sulfide and tar.

According to one embodiment of the present invention the acid tar and Solvay process byproduct are combined and fed into a gasifier or other suitable reactor from which calcium sulfide can be recovered and separated from the tar phase of the reaction products. The resulting calcium sulfide can be used to stabilize heavy metal containing wastes such as chromite ore processing residue (COPR). As can be understood, when the byproducts from a Solvay process contain calcium carbonate and other components of the limestone, the resulting calcium sulfide produced by the reaction with acid tar is suitable for use as a heavy metal waste stabilizing agent according to the present invention.

The calcium sulfide produced from the process of the present invention can be used to effectively stabilize heavy metal containing waste materials, including waste materials that contain lead, cadmium, chrome, copper, mercury and nickel. Such waste materials can be contaminated soil, process residues and the like. In addition the calcium sulfide of the present invention can be used to remove, e.g. precipitate, heavy metal contaminates from water, process streams, and the like.

The heavy metal containing waste materials are stabilized according to the present invention by treating the heavy metal containing waste materials with an aqueous solution of the calcium sulfide of the present invention and controlling pH and oxidation reduction potential. The pH can be controlled by adding conventional pH controlling agents. The oxidation reduction potential can be controlled by adjusting the dosage of the calcium sulfide thereby targeting specific heavy metals that are to be stabilized.

Under the Resource Conservation and Recovery Act (RCRA), the U.S. Environmental Protection Agency (EPA) sets levels of treatment and treatment standards which substantially reduce the toxicity of hazardous wastes or substantially reduce the likelihood of migration of hazardous constituents from wastes. In general the calcium sulfide of the present invention is used to stabilize heavy metal containing waste materials according to conventional treatment standards/protocols. However, the present invention uses a calcium sulfide reagent that includes contaminates such as silica or magnesium, which preclude the calcium sulfide from being of a reagent quality/purity, but which do not adversely affect the ability of the calcium sulfide from being used to stabilize heavy metal containing waste materials. Otherwise the calcium sulfide that is produced from waste byproducts such as from a Solvay process that contain calcium carbonate and other components of the limestone according to the present invention is suitable for stabilizing heavy metal containing waste materials.

Thus the present invention provides a combined process of producing a reagent from one waste byproduct and using the reagent to stabilize another waste material. The overall result is the productive use of one waste material (waste gypsum or Solvay process byproducts and acid tar) and the stabilization of another waste material (heavy metal containing wastes), thus allowing for the disposal of two (or more) waste materials.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method of disposing of two or more waste materials, including at least one hazardous waste material, which method comprises the steps of:
a) obtaining a waste byproduct;
b) producing a reagent from the waste byproduct which reagent may include one or more contaminates;
c) obtaining a waste material containing one or more hazardous heavy metals;
d) treating the hazardous heavy metal containing waste material with the reagent from step b) to stabilize the hazardous heavy metal containing waste material; and
e) disposing of the stabilized hazardous heavy metal containing waste material.

2. A method of disposing of two or more waste materials according to claim 1, wherein:
the waste byproduct obtained in step a) is waste gypsum; and
the waste gypsum is processed into calcium sulfide in step b).

3. A method of disposing of two or more waste materials according to claim 1, wherein:
the waste byproduct obtained in step a) is a calcium carbonate containing waste byproduct; and
the calcium carbonate containing waste byproduct is processed into calcium sulfide in step b).

4. A method of disposing of two or more waste materials according to claim 3, wherein:
the calcium carbonate containing waste byproduct is obtained from a Solvay process.

5. A method of disposing of two or more waste materials according to claim 1, wherein the heavy metal containing waste material contains at least one of lead, cadmium, chrome, copper, mercury and nickel.

6. A method of disposing of two or more waste materials according to claim 2, wherein in step b) the waste gypsum is combined with a source of carbon and heated to produce the calcium sulfide.

7. A method of disposing of two or more waste materials according to claim 6, wherein the waste gypsum and source of carbon are heated to a temperature of between about 800 and 1,000° C.

8. A method of disposing of two or more waste materials according to claim 6, wherein the waste gypsum and source of carbon are heated in a reducing atmosphere.

9. A method of disposing of two or more waste materials according to claim 2, wherein in step b) the reagent is produced in one of a tunnel kiln, a rotary kiln and a batch kiln.

10. A method of disposing of two or more waste materials according to claim 2, wherein the waste gypsum is obtained from a flue gas.

11. A method of disposing of two or more waste materials according to claim 10, wherein the waste gypsum is obtained by a flue gas desulfurization process.

12. A method of disposing of two or more waste materials according to claim 3, wherein in step b) the calcium carbonate containing waste byproduct is combined with acid tar and heated to produce the calcium sulfide.

15. A method of stabilizing heavy metal containing waste materials which method comprises the steps of:
a) obtaining a waste byproduct;
b) producing a reagent from the waste byproduct which reagent may include one or more contaminates;
c) obtaining a waste material containing one or more hazardous heavy metals; and
d) treating the hazardous heavy metal containing waste material with the reagent from step b) to stabilize the hazardous heavy metal containing waste material.

16. A method of disposing of two or more waste materials according to claim 15, wherein:
the waste byproduct obtained in step a) is waste gypsum; and
the waste gypsum is processed into calcium sulfide in step b).

17. A method of disposing of two or more waste materials according to claim 15, wherein:
the waste byproduct obtained in step a) is a calcium carbonate containing waste byproduct; and
the calcium carbonate containing waste byproduct is processed into calcium sulfide in step b).

18. A method of disposing of two or more waste materials according to claim 17, wherein:
the calcium carbonate containing waste byproduct is obtained from a Solvay process.

19. A method of disposing of two or more waste materials according to claim 15, wherein the heavy metal containing waste material contains at least one of lead, cadmium, chrome, copper, mercury and nickel.

20. A method of disposing of two or more waste materials according to claim 16, wherein in step b) the waste gypsum is combined with a source of carbon and heated to produce the calcium sulfide.

21. A method of disposing of two or more waste materials according to claim 20, wherein the waste gypsum and source of carbon are heated to a temperature of between about 800 and 1,000° C.

22. A method of disposing of two or more waste materials according to claim 20, wherein the waste gypsum and source of carbon are heated in a reducing atmosphere.

23. A method of disposing of two or more waste materials according to claim 16, wherein in step b) the reagent is produced in one of a tunnel kiln, a rotary kiln and a batch kiln.

24. A method of disposing of two or more waste materials according to claim 16, wherein the waste gypsum is obtained from a flue gas.

25. A method of disposing of two or more waste materials according to claim 24, wherein the waste gypsum is obtained by a flue gas desulfurization process.

26. A method of disposing of two or more waste materials according to claim 17, wherein in step b) the calcium carbonate containing waste byproduct is combined with a acid tar and heated to produce the calcium sulfide.

27. A method of stabilizing heavy metal containing waste materials according to claim 15, further comprising the step of disposing of the stabilized heavy metal containing waste material in a landfill.

28. A stabilized heavy metal containing waste material produced by the method of claim 15.
